(19) United States
(12) Patent Application Publication
(10) Pub. No.: US 2017/0310024 A1
(43) Pub. Date: Oct. 26, 2017

(54) DEVICE FOR THE ELECTROMAGNETICALLY COMPATIBLE CONNECTION OF ELECTRICAL CONDUCTORS WITH A SCREENING LAYER

(71) Applicant: SUMITOMO ELECTRIC BORDNETZE GmbH, Wolfsburg (DE)

(72) Inventor: Ole ADAM, Braunschweig (DE)

(21) Appl. No.: 15/513,491

(22) PCT Filed: Sep. 10, 2015
(86) PCT No.: PCT/EP2015/070704

§ 371 Date: Mar. 22, 2017

(30) Foreign Application Priority Data
Oct. 2, 2014 (DE) 10 2014 220 016.4

(51) Int. Cl. H01R 9/05

(52) U.S. Cl. CPC H01R 9/0518; H01R 2201/26

(57) ABSTRACT

The subject of the present invention is a device for the electromagnetically compatible connection of electrical conductors (3₁, 3₂, 3ₙ) with screening layers (2₁, 2₂, 2ₙ) against interference fields, particularly in motor vehicles. The conductors (3₁, 3₂, 3ₙ) to be connected are held in a housing (5) of the device, also known as a high-voltage distributor. In order to guarantee the electromagnetic screening, the screening layers (2₁, 2₂, 2ₙ) of the stripped cables are folded backwards and pulled over contact sections (1₁, 1₂, 1ₙ) of the housing (5) provided for the purpose, as a result of which electrical contacting occurs. The screening layers (2₁, 2₂, 2ₙ) are affixed by one clamp (4₁, 4₂, 4ₙ) respectively.

The subject of the present invention is a device for the electromagnetically compatible connection of electrical conductors with a screening layer against interfering fields, which comprises the features named in the generic term of claim 1.

Electrical connectors for which the electromagnetic compatibility is a requirement are used for example in motor vehicles, in electrical communication engineering, in airplanes or in other technical areas. In cars, supply voltages are provided at different voltage levels and are distributed in different areas of the vehicle. For this purpose, the electrical conductors are brought together in cable harnesses, laid and re-separated. The individual cables are brought together and separated via distributor pieces. In the area of higher voltage levels, such as in cars from 60 volts and above, these are also known as high voltage distributors. These are subject to special safety requirements. In complex mechatronic systems such as modern cars, high standards also apply to the electromagnetic compatibility of the installed components. The use of electrical energy entails the formation of electrical, magnetic or electromagnetic fields. These fields can impair other electrical and electronic components or their functioning. The term “electromagnetic compatibility” relates to the avoidance of such mutual and usually negative impact of the interference fields generated on electrical and electronic components. For this reason, voltage supply cables are screened against interference fields. They consist of two electrically conductive wires for example which are encased in a plastic electrical insulation layer. This is followed for example by another shared plastic layer which encases both cable looms which are already insulated in themselves. This layer is in turn surrounded by a screening layer which can for example take the form of a conductive metal foil or braid, and which provides a screen against the interference fields described above. In order to protect the screening layer, it is usually surrounded by a further plastic layer, which forms the outer sheath of the cable.

In order to connect such cables with a voltage source or drain, for the purpose of voltage distribution, for example in a car, it must be stripped in the area of the interfaces, i.e. it must be freed of screening and protection layers in order to make the conductive wires accessible again. As a result, the screening layer is interrupted, making measures for securing the electromagnetic compatibility necessary.

In DE 10 2005 033 910 A1, a screen connector is described in which several wires run into a shared connector housing. The screens of the individual wires are affixed between a sleeve and a bush in each case, which are screwed onto the connector housing via a panel section.

In DE 600 03 279 T2, a screened connector (protection connector) is described in which an electrically conductive sleeve is connected to the exposed screening layer of a conductor. The sleeve is in turn contacted with an electrically conductive flange, which is affixed to a protective wall. Additionally, the protective connector has a housing which affixes to each other the wire to be protected (protected line) and the flange.

In EP 0 896 751 A1, a device is described for the electrical contacting of a cable screen with a connector housing. The device has a support plate and a clamping bush. The clamping bush is inserted into the support plate in such a way that a cable screen lying between them is clamped in and is electrically contacted.

The observations regarding the prior art clearly show that solutions known to date make use of a large number of individual parts such as bushes and plates, or additional housing. This increases complexity and costs. The construction space requirement and the effort involved in mounting are negatively impacted. Additionally, the number of potential replacement parts increases.

The object of the present invention is to create a high-voltage distributor or a device to which several screened electrical conductors can be connected without negatively impacting the electromagnetic compatibility as a result. The device should here be characterized by a simple structure.

This object is attained by means of a device with the features named in claim 1. The device consists of a housing, which is electrically conductive at least in sections. It is suitable for guiding, at least in sections, screened conductors to be connected. In the area of an exposed screen layer of the conductor to be connected, an electrically conductive portion of the housing can be contacted with the screening layer of the conductor. According to the invention, the housing stands out in this area to the extent that the screening layer of the conductor can be folded over backwards and be pulled back over a contact section of the housing. According to the invention, the part of the screening layer of the respective conductor that is folded over the contact section is affixed there with a single clamp, wherein the connection can be force-fit, form-fit or a mixture of both types of connection.

The advantage of this solution is that as well as the housing of the high-voltage distributor, a maximum of one additional component is installed for each conductor to be connected.

Further preferred embodiments of the invention emerge from the features named in the subclaims.

Thus, the contact sections for contacting the conductor can be designed concentrically around the respective conductor. The clamps used are preferably designed as a single piece. The clamp connection preferably has a low electrical contact resistance. This has a positive effect on aging behavior and resistance capacity against environmental influences. In one preferred embodiment of the present invention, more than two conductors can be connected to each other. The housing of the device is preferably made of several parts, and can in particular consist of a housing base part and a housing lid, wherein at least two housing parts are connected to each other in such a manner that they are electrically conductive. The housing is preferably sealed against the environment. Advantageously, the housing can be equipped with an insulating layer, for example made of plastic or paint, which surrounds the housing as a closed layer. As a result, no grounding of the housing is necessary.

In a further preferred embodiment of the invention, the device has a locking mechanism via which the conductors to be connected can be positioned on the housing.

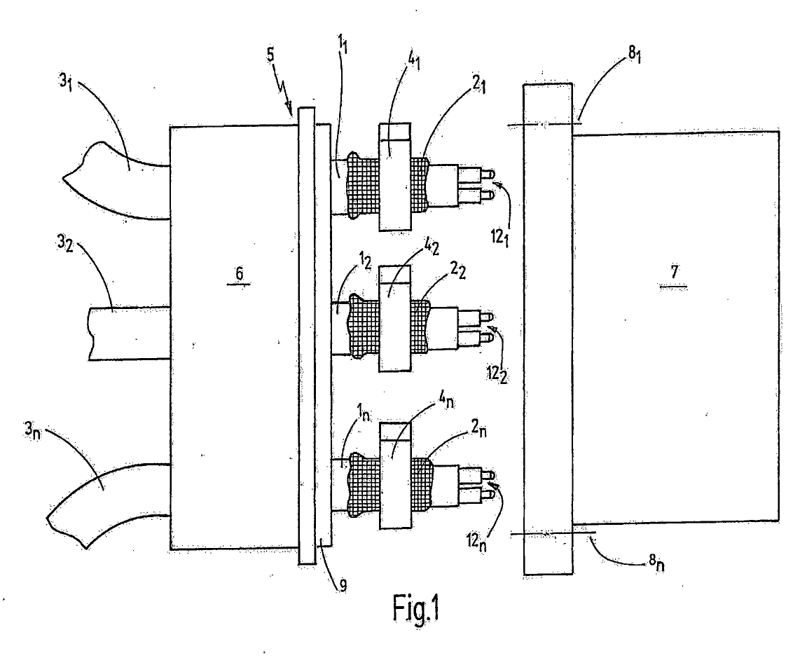

A preferred embodiment of the present invention is described below with reference to FIGS. 1 to 3. The numbering of the components applies to all figures equally, and is followed by an explanation.

FIG. 1 shows a device according to the invention with an opened housing lid:

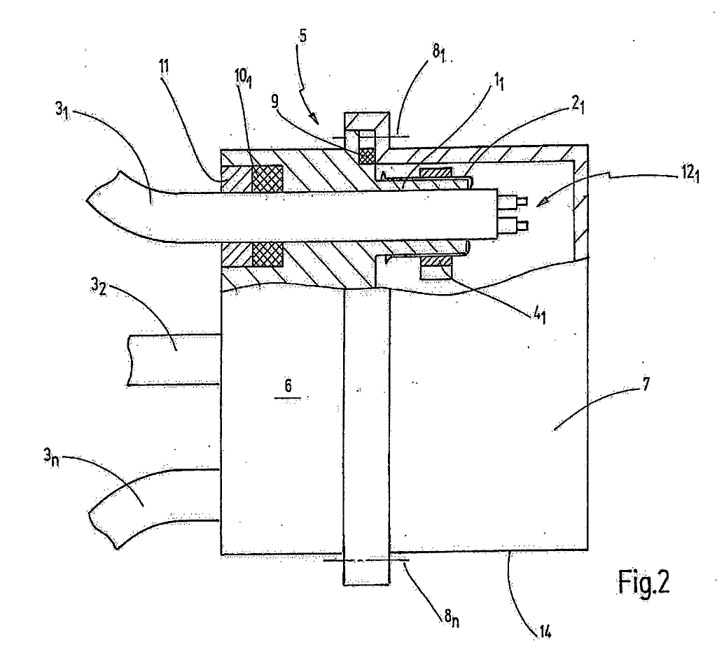

FIG. 2 shows the device with a closed housing lid and a drawn break; and

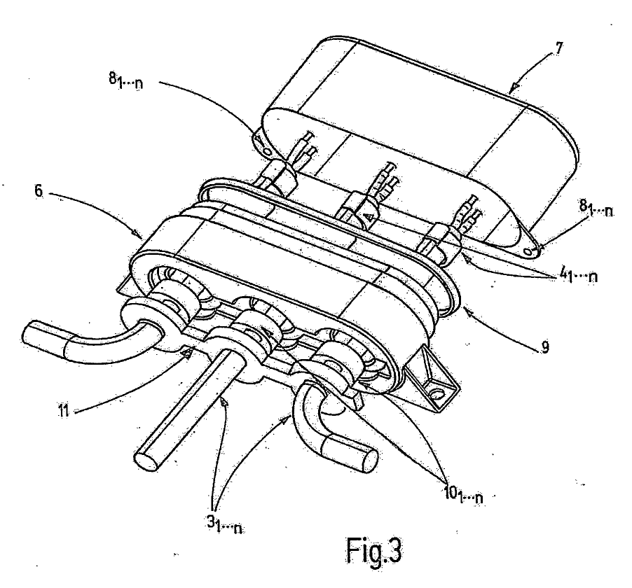

FIG. 3 shows a schematic perspective view of a high-voltage distributor.

Contact sections 1₁, 1₂, 1ₙ of a housing 5, which are contacted in an electrically conductive manner with screening layers 2₁, 2₂, 2ₙ to connecting conductor 3₁, 3₂, 3ₙ, are concentrically designed in the form of hollow cylinders around the respective conductor 3₁, 3₂, 3ₙ. In order to affix the screening layers 2₁, 2₂, 2ₙ, clamps 4₁, 4₂, 4ₙ are used which are designed as a single piece and which create a form-fit connection between the screening layers 2₁, 2₂, 2ₙ and the contact sections 1₁, 1₂, 1ₙ. The housing 5 is designed in such a manner that a plurality of conductors 3₁, 3₂, 3ₙ are held in it, and can be contacted with the housing 5 in the manner and style described above. The conductors 3₁, 3₂, 3ₙ are arranged in the housing 5 such that the construction can be easily scaled in accordance with the number of conductors 3₁, 3₂, 3ₙ to be connected. Preferably, the housing 5 is designed in several parts and consists in the present embodiment of a housing base part 6 and a housing lid 7. The housing lid 7 is affixed on the housing base part 6 via screws 8₁, 8ₙ. The interface between the two housing parts 6, 7 and the interfaces in the area of the entry of the conductors 3₁, 3₂, 3ₙ into the housing base part 6, are equipped in relation to the environment with a housing seal 9 and with cable seals 10₁, 10₂, 10ₙ. Both housing parts 6, 7 are connected to each other in an electrically conductive manner. The housing 5 is also equipped with a closed insulating layer 14. Before entry of the conductors 3₁, 3₂, 3ₙ into the housing, they are positioned by a locking mechanism 11. Wires 12₁, 12₂, 12ₙ of the conductors 3₁, 3₂, 3ₙ which are exposed for electrical connection are shown in a non-connected state.

The described device according to the invention is preferably used in motor vehicles, in particular in passenger cars. It is used for the distribution of voltages, in particular of those over 60 volts, in the vehicle, and for the connection of screened electrical conductors, wherein the electromagnetic compatibility is not impaired.

### LIST OF REFERENCE NUMERALS

1₁, 1₂, 1ₙ Contact sections 1 to n
2₁, 2₂, 2ₙ Screening layers 1 to n
3₁, 3₂, 3ₙ Conductors 1 to n
4₁, 4₂, 4ₙ Clamps 1 to n
5 Housing
6 Housing base part
7 Housing lid
8₁, 8ₙ Screws 1 to n
9 Housing seal
10₁, 10₂, 10ₙ Cable seals 1 to n
11 Locking mechanism
12₁, 12₂, 12ₙ Wires 1 to n
13 Break
14 Insulating coating

1. A device for the creation of an electromagnetically compatible and electrically conductive connection between electrical conductors (3₁, 3₂, 3ₙ) with a screening layer (2₁, 2₂, 2ₙ) against interference fields, for the guidance of which a housing (5) is provided which is electrically conductive at least in sections, which is in contact with the screening layers (2₁, 2₂, 2ₙ) of the conductors (3₁, 3₂, 3ₙ),
characterized in that
the screening layer (2₁, 2₂, 2ₙ) of at least one conductor (3₁, 3₂, 3ₙ) is drawn by folding over and pulling back over a contact section (1₁, 1₂, 1ₙ) of the housing (5) and is affixed on the contact section (1₁, 1₂, 1ₙ) with a clamp (4₁, 4₂, 4ₙ).

2. The device according to claim 1,
characterized in that
the clamp connection has a low electrical contact resistance.

3. The device according to claim 1,
characterized in that
the contact sections (1₁, 1₂, 1ₙ) are designed concentrically around the conductors (3₁, 3₂, 3ₙ) to be connected.

4. The device according to claim 1,
characterized in that
the clamps (4₁, 4₂, 4ₙ) used are designed as a single piece.

5. The device according to claim 1,
characterized in that
more than two conductors (3₁, 3₂, 3ₙ) are connected.

6. The device according to claim 1,
characterized in that
the housing (5) is designed as several parts, and comprises at least one housing base part (6) and a housing lid (7).

7. The device according to claim 1,
characterized in that
the housing parts (6, 7) are connected to each other in an electrically conductive manner.

8. The device according to claim 1,
characterized in that
the housing (5) is sealed against the environment.

9. The device according to claim 1,
characterized in that
the conductors (3₁, 3₂, 3ₙ) are positioned on the housing (5) via a locking mechanism (11).

10. The device according to claim 1, characterized in that the housing (5) is electrically insulated against the environment.
